(19) United States
(12) Patent Application Publication
(10) Pub. No.: US 2013/0189606 A1
(43) Pub. Date: Jul. 25, 2013

(54) ASSEMBLY FOR A FUEL CELL AND METHOD FOR THE PRODUCTION THEREOF

(71) Applicants: Matthias Ruettinger, Reutte (AT); Marco Brandner, Oy-Mittelberg (DE); Thomas Franco, Huettlingen (DE); Andreas Venskutonis, Reutte (AT); Robert Muecke, Juelich (DE); Norbert Menzler, Juelich (DE); Hans Peter Buchkremer, Heinsberg (DE)

(72) Inventors: Matthias Ruettinger, Reutte (AT); Marco Brandner, Oy-Mittelberg (DE); Thomas Franco, Huettlingen (DE); Andreas Venskutonis, Reutte (AT); Robert Muecke, Juelich (DE); Norbert Menzler, Juelich (DE); Hans Peter Buchkremer, Heinsberg (DE)

(21) Appl. No.: 13/510,080

(22) PCT Filed: Nov. 17, 2010
(86) PCT No.: PCT/EP2010/007002

§ 371 Date: Jun. 14, 2012

(30) Foreign Application Priority Data
Nov. 18, 2009 (EP) 09014400.7

(51) Int. Cl. H01M 8/02

(52) U.S. Cl. CPC H01M 8/0202
USPC 429/508; 427/115

(57) ABSTRACT

The invention relates to an assembly comprising an electrode, an electrolyte, and a carrier substrate. The assembly is suitable for a fuel cell. An adaptation layer for adapting the electrolyte to the electrode is disposed between the electrode and the electrolyte, wherein the mean pore size of the adaptation layer is smaller than the mean pore size of the electrode.

The invention relates to an assembly for a fuel cell, comprising an electrode and an electrolyte, and to a method for producing the assembly.

When producing high-temperature fuel cells, a substrate is typically used, to which an electrolyte and two electrodes (cathode and anode) are applied. For example, first, the anode is applied to the substrate, then the electrolyte, and finally the cathode. These components of the fuel cell that are applied in layers are electrochemically active cell layers and are also referred to as cathode-electrolyte-anode (CEA) units, as is known from DE 103 43 652 A1, for example. The substrate acts as a mechanical carrier for the CEA unit and, for example, is made of ceramic material or metal.

DE 103 43 652 A1 provided a metallic substrate, for example a porous body that is made of sintered or pressed metal particles. Metal substrates have the advantage of allowing good thermal adjustment to a so-called interconnector, and allowing technically simple electrical contact with this interconnector. The interconnector, which is also referred to as a bipolar plate or current collector, is disposed between two fuel cells and electrically connects the individual fuel cells in series. Moreover, the interconnectors mechanically support the fuel cells, and assure separation and guidance of the reaction gases on the anode and cathode sides.

The electrolyte is disposed between the anode and cathode. The electrolyte must satisfy several requirements. It must conduct oxygen ions, yet have an insulating effect with respect to electrons. The electrolyte must also be gas-tight. Moreover, undesirable chemical reactions between the electrolyte and an adjoining electrode must be prevented. So as to meet these requirements, DE 10 2007 015 358 A1 describes a multi-layer composition for an electrolyte, comprising at least three layers.

It is the object of the invention to provide an assembly which simplifies the composition of a fuel cell. It is a further object of the invention to provide a method for producing such an assembly.

These objects are achieved by an assembly having the feature combination of claim 1 and by a method for producing the assembly having the feature combination of claim 14.

According to the invention, an adaptation layer is provided in the assembly between an electrode and the electrolyte. This adaptation layer achieves a good connection or adaptation of the electrolyte to the electrode. In addition, it is favorable in terms of a flat composition of the assembly or fuel cell when a metallic porous carrier substrate is provided for the electrodes and the electrolyte.

Compared to ceramic carrier substrates, metallic porous carrier substrates have greater mechanical stability and can be provided in a particularly thin substrate thickness. In addition, the gas-tight electrolyte should be designed as thin as possible. This necessitates as low a roughness as possible at the electrode surface (for example anode surface) associated with the electrolyte. The electrode material must therefore be applied to the carrier substrate such that this desired low surface roughness at the electrode is achieved. This conflicts with the relatively high surface roughness of the metallic porous carrier substrate. Achieving the desired low surface roughness at the electrode also becomes more difficult when the electrode (notably as an anode) is produced at reduced process conditions by means of sintering on the carrier substrate, because this creates a coarser roughness at the electrode surface. These problems are solved according to the invention by designing the mean pore size of the adaptation layer smaller than the mean pore size of the electrode. This relationship between the mean pore sizes applies at least to the near-surface layer regions of the surfaces of the electrode layer and adaptation layer, which face the electrolyte. This relationship preferably applies to the entire layer thickness of electrode and adaptation layer. Using the aforementioned relationship of the mean pore sizes, a surface structure which simplifies the application of a gas-tight thin-film electrolyte in terms of the technology is provided in the assembly. It is possible, in particular, to apply especially thin electrolyte layers (<10 μm), by way of the adaptation layer, for example by way of physical vapor deposition (PVD), and more particularly by way of electron beam evaporation or sputter processes, or sol gel methods, in a gas-tight manner. According to the material of the adaptation layer, a single thin electrolyte layer is thus sufficient for the proper function of the fuel cell, which simplifies the production of the fuel cell. Moreover, the inner cell resistance of the fuel cell is significantly reduced as compared to fuel cell comprising plasma-sprayed electrolytes, which require a layer thickness of approximately 40 μm to achieve sufficient gas-tightness, thereby allowing higher power outputs to be achieved.

In terms of the material and structure, notably the pore structure, the adaptation layer can be selected such that an electrolyte can always be applied to an electrode (anode or cathode) by way of an interposed adaptation layer.

The adaptation layer is advantageously used with reduced anode layer structures which do not allow a direct application of a gas-tight electrolyte layer. Such reduced anode layer structures are obtained, for example, in connection with metallic substrates. These substrates are preferably produced by way of powder-metallurgy and provided notably in panel form. A central region of this substrate is usually porous and used as a mechanical carrier for the electrochemically active cell layers. These cell layers can, for example, be produced by way of wet-chemical coating (such as screen printing or wet powder spraying), followed by sintering or thermal spraying methods (such as plasma spraying or high-velocity oxy-fuel spraying). Compared to ceramic carrier substrates, metallic carrier substrates have the advantage of being more thermally resistant and more redox-stable during operation. However, oxidation of the carrier substrate during production must be avoided, because the formation of metal oxide would effect changes in volume in the carrier substrate, which would jeopardize defect-free application of the electrode and electrolyte onto the carrier substrate. In addition, the electrical resistance of the carrier substrate increases when the same oxidizes, which would be disadvantageous for the subsequent cell performance. Sintering of the anode structure, which is applied to the carrier substrate, is thus carried out in a reduced atmosphere, whereby the anode structure is present in reduced, porous form. The nickel oxide contained in the anode structure prior to sintering is reduced during the sintering process, which leads to coarsening of the particle size thereof due to the high sintering activity, and pores having relatively large diameters (for example 2 μm) are obtained. Such an anode surface structure is frequently not suitable for applying a gas-tight thin-film electrolyte directly to the anode structure. In particular, the desired gas-tightness of the electrolyte is not assured when the electrolyte is applied to the anode structure by means of vapor deposition (for example, PVD method). This problem is solved by means of the aforementioned adaptation layer.

Roughness may be used to physically characterize a surface. The primary profile was optically measured (confocal laser topography) and the filtered roughness profile and the roughness values were calculated in accordance with DIN EN ISO 11562 and 4287. The scanning length (l_{f}), total measured length (lₙ), and single measured length (lᵣ) were selected in accordance with DIN EN ISO 4288. According to DIN EN ISO 4287, the arithmetic mean roughness Rₐ indicates the arithmetic average of the absolute values of all profile values of a roughness profile. The root mean square roughness R_{q} (also referred to as the mean surface roughness R_{q}) is the root mean square of all profile values and gives greater consideration to outliers than the arithmetic mean roughness Rₐ. According to DIN EN ISO 4287, the average roughness depth R_{z} is defined as the arithmetic mean of the individual roughness depths of all single measured lengths. A single roughness depth thus denotes the distance between the highest peak and the lowest trough of a single measured length. The total measured length is divided into five identically sized, consecutive segments (single measured lengths). Since the R_{z} value is determined by the deepest valleys and the highest peaks, it is especially dependent on the measurement method that is used. When using, for example, mechanical contact stylus methods, instead of the optical methods used here, consideration must be given to the fact that it may not be possible to detect all sharp valleys, depending on the tip geometry that is used.

DIN EN ISO 4288 defines the breakdown of the primary profile into a waviness component that can be neglected in the roughness calculation (long waves) and into the actual roughness component (short waves) by way of a filter cut-off wavelength that is dependent on the roughness values that are achieved. For an arithmetic mean roughness Rₐ greater than 0.02 μm and less than, or equal to, 2.00 μm, for example, a cut-off wavelength λ_{c} of 0.8 mm is provided (with lᵣ=λ_{c}). However, irregularities of this wavelength do not play a crucial role for the quality and tightness of the layer, especially for layers applied by vapor deposition (PVD), but irregularities having a considerably shorter wavelength do. This invention therefore uses not only roughness according to DIN, but also so-called micro-roughness, which is based on a cut-off wavelength of 0.15 mm, with otherwise identical total measured lengths. This accordingly increases the number of the single measured lengths (normally 5), because lᵣ=λ_{c} always applies. This micro-roughness was correspondingly labeled Rₐ^{μ}, R_{q}^{μ}, and R_{z}^{μ}.

Additional characteristic parameters that maybe used to describe the properties of a sintered layer include the mean pore size and the sinter particle size. Both measures can be determined for arbitrary, including open-pored, structures using the intercepted-segment method on scanning electron microscopic images of cross-section polishes. For this purpose, first the individual phases (particles, pores) are appropriately marked in the images by means of differences in contrast, particle shape, or element analysis (for example, energy-dispersive X-ray spectroscopy, EDX), then straight lines are drawn statistically, and the intersecting points are marked at the transitions between the different phases. The average value of all lengths of the sections thus obtained, which are located in a phase, reflects the mean intersecting line length for this phase (for example pores). This mean intersecting line length is converted into the actual particle size or pore size by multiplication with a corresponding geometry factor. Assuming the typically employed model representation of pores around tetradecahedric particles according to reference [1], the value 1.68 is used as the geometry factor and the value 1.56 is used for the particle size [2].

When reference is made in the present invention to sinter particle sizes, it shall be understood to mean the morphologically discernible particle size of the structure. The samples were not etched prior to analysis.

The maximum pore size was determined from the largest inside diameters of all pores using a series of scanning electron microscopic images. The inside diameter of a pore to this end denotes the length of the largest straight length within the pore.

For the pore and particle sizes to be determined, suitable magnification of the microscopic image must be ensured. In particular, the pore or particle size to be determined still requires resolution, yet must still be captured fully by the image detail.

As previously mentioned, the adaptation layer allows the electrolyte to be applied directly, wherein, with a view to a simplified, space-saving composition for the fuel cell, additional intermediate layers between the electrolyte and the adaptation layer can be omitted.

The mean pore size of the adaptation layer is preferably no more than half the mean pore size of the electrode. It is thus also possible to apply a gas-tight thin-film electrolyte (<10 μm) by way of PVD, notably by way of electron beam evaporation or sputter processes, or sol-gel technologies.

The mean size of the pores (at least in the near-surface layer region of the layer surface facing the electrolyte) of the adaptation layer preferably does not exceed 500 nm. This is favorable in terms of homogeneous growth of the electrolyte material (for example as a PVD layer) on the adaptation layer. The risk with mean pore sizes above 500 nm is that the pores can no longer be sealed in a gas-tight manner when using a thin electrolyte layer. The mean pore size of the adaptation layer (at least in the near-surface region of the layer surface facing the electrolyte) notably does not exceed 350 nm, and still more preferably does not exceed 250 nm.

The mean surface roughness of the adaptation layer preferably has a root mean square roughness R_{q} of less than 2.5 μm, preferably no more than 1.5 μm, and still more preferably of no more than 1.0 μm. A root mean square roughness R_{q} greater than 2.5 μm will result in potential leakage in the subsequent thin-film electrolyte. For example, intercolumnar spaces may develop during the growth of a subsequent PVD layer. In the case of sol-gel thin-film electrolytes, higher roughness means that wetting of the profile tips can no longer be assured or that the critical layer thickness in the profile valleys is exceeded, resulting in cracking of the thin-film electrolyte.

A diffusion barrier is preferably disposed between the carrier substrate and an electrode, notably the anode. The barrier can prevent metallic interdiffusion and other reactions between the substrate and electrode, and thus contributes to the long-term stability and higher durability of the assembly.

The adaptation layer preferably has a thickness of 3 to 20 μm. If the layer thickness is less than 3 μm, the adaptation layer cannot fully compensate for the roughness of the electrode layer beneath, thus making a gas-tight application of a thin-film electrolyte with homogeneous layer growth impossible. If the layer thickness were greater than 20 μm, theohmic resistance of this layer system (adaptation layer and electrolyte) would be in a range that offers no significant performance benefit over conventional metal-supported SOFCs (solid oxide fuel cells) comprising a plasma-sprayed electrolytes.

The electrolyte applied to the adaptation layer preferably has a layer thickness of 0.2 to 10 μm. If the layer thickness is below 0.2 μm, the required gas tightness of the electrolyte layer is not assured. The increase in layer thickness of the electrolyte is accompanied by a significant rise in ohmicresistance, and consequently, by a reduction in output of the fuel cell; thus a maximum layer thickness of 10 μm is preferred.

The assembly comprising the electrolyte and the adaptation layer is preferably used in a fuel cell, and more particularly a high-temperature fuel cell. High-temperature fuel cells include solid oxide fuel cells, or SOFC. Because the SOFC has high electrical efficiency and the waste heat developing at high operating temperatures may be recovered, it is particularly suitable as a fuel cell.

For example, a ferriticFeCrMx alloy and a chromium-based alloy are suitable materials for the metallic substrate. In addition to iron, the FeCrMx alloy usually contains chromium at between 16 and 30% by weight, and additionally at least one alloying element at a content of 0.01 to 2% by weight from the group of rare earth elements or oxides thereof, such as Y, Y₂O₃, Sc, Sc₂O₃, or from the group consisting of Ti, Al, Mn, Mo, and Co.

Ferrochrome (1.4742), CrAl₂O₅ (1.4767), and CroFer 22 APU from Thyssen Krupp, FeCrAlY from Technetics, ZMG 232 from Hitachi Metals, SUS 430 HA and SUS 430 Na from Nippon Steel, as well as all ODS iron-based alloys of the ITM class from Pansee, such as ITM Fe-26Cr—(Mo, Ti, Y₂O₃), shall be mentioned by way of example as suitable ferritic steels.

As an alternative, the porous metallic substrate may also be a chromium-based alloy, which is to say a chromium content of more than 65% by weight, and an example is Cr5FeIY or Cr5FeIY₂O₃.

Individual layers of the fuel cell are applied to the provided metallic porous substrate. The following functions or layers are preferably applied consecutively:

1) an optional diffusion barrier layer (to prevent metallic interdiffusion between the substrate and electrode, notably with anodes);
2) a first electrode (anode or cathode);
3) an electrolyte;
4) an optional diffusion barrier to prevent reactions between the electrolyte and electrode, notably with high-performance cathodes made of LSCF (lanthanum strontium cobalt ferrite); and
5) a second electrode (cathode or anode).

The diffusion barrier layer comprises, for example, lanthanum strontium manganite (LSM), lanthanum strontium chromite (LSCR), or gadolinia-doped ceria (CGO). The anode may be composed as a multi-layer laminate or as an individual layer. The same basically applies to the cathode. To start, a first electrode is applied to the substrate, for example by means of a wet-chemical method.

As described above, a porous adaptation layer is applied to the electrode. The electrolyte can be applied in a gas-tight manner to the adaptation layer with low complexity in terms of the method, because the mean pore size of the adaptation layer is smaller than the mean pore size of the electrode.

A suitable layer thickness of the adaptation layer is advantageously achieved by applying it to the electrode using a wet-chemical method. This can, for example, be done by means of screen printing, immersion coating, or slip casting.

The adaptation layer can also be optionally applied as multiple layers. In this case, the material of the adaptation layer is repeatedly applied in multiple steps. For example, the electrode is immersion-coated several times and dried between individual coating processes. The application in multiple layers supports a homogeneously composed adaptation layer. Irregular surfaces of the adaptation layer are prevented. This in turn creates advantageous physical conditions for applying the electrolyte material to the adaptation layer.

In a preferred embodiment, the adaptation layer comprises a strictly ion-conducting material, which is to say a non-electron-conducting material. The required electrical insulation between the two electrodes (anode and cathode) is thus already assured by the adaptation layer. Further electronic insulation layers can be omitted, thus simplifying the composition of the fuel cell. Thus the gas-tight electrolyte can also comprise a layer, which, for example, has significant electronic conductivity under the operating conditions of the fuel cell. This is the case, for example, with an electrolyte comprising gadolinia-doped ceria (CGO) at higher temperature (>650° C.).

An oxide ceramic material, for example doped zirconium oxide, is the preferred material used for the non-electron-conducting adaptation layer. At least one oxide of the doping elements from the group consisting of Y, Sc, Al, Sr, and Ca is suitable for doping. The adaptation layer may be configured as a YSZ layer (yttrium oxide-stabilized zirconia).

As an alternative, a material that conducts ions and electrons (mixed conductor) is used for the adaptation layer. Doped cerium oxide is particularly suited for this purpose. Advantageously, at least one oxide of the doping elements from the group of rare earth elements, such as GdorSm, and/or from the group consisting Y, Sc, Al, Sr, and Ca are used for doping. The adaptation layer may be designed as a CGO layer. In this case, the electrical insulation between the two electrodes should come from the gas-tight electrolyte layer. An oxide ceramic material, for example doped zirconium oxide, is the preferred material used for the non-electron-conducting thin-film electrolyte. At least one oxide of the doping elements from the group consisting of Y, Sc, Al, Sr, and Ca is suitable for doping. The thin-film electrolyte may be configured as a YSZ layer (yttrium oxide-stabilized zirconia).

The materials mentioned above for the adaptation layer may also be used for the electrolyte, depending on the particular application. For example, in the case of an electrolyte comprising CGO material, it is also possible to apply cathodes directly to this electrolyte, which are designed as a Sr component reacting with ZrO₂, for example lanthanum strontium cobalt ferrite (LSCF) or lanthanum strontium cobaltite (LSC).

The adaptation layer applied to the electrode is preferably sintered. The sintering temperature is notably 950° C. to 1300° C., whereby no undesirable structural changes are to be expected in the adaptation layer during operation of the fuel cell (for example SOFC, up to 850° C.). So as to achieve sufficient mechanical stability, a powder having a mean particle size between 30 and 500 nm, and more particularly 150 nm, is preferably used for the adaptation layer. This additionally prevents excessive infiltration in a porous electrode layer (for example the anode layer).

The adaptation layer provides the option of producing a stable and gas-tight electrolyte layer structure by way of vapor deposition. This method also allows especially thin electrolyte layers. For example, an electrolyte having a layer thickness of 0.2 to 10 μm, preferably 1 to 3 μm, and still more preferably 1 to 2 μm, can be deposited on the adaptation layer. The PVD (physical vapor deposition) method is particularly suitable for this purpose.

As an alternative, the electrolyte can be applied by way of sol-gel technology.

The invention will be described in more detail hereafter based on several figures and one specific exemplary embodiment.

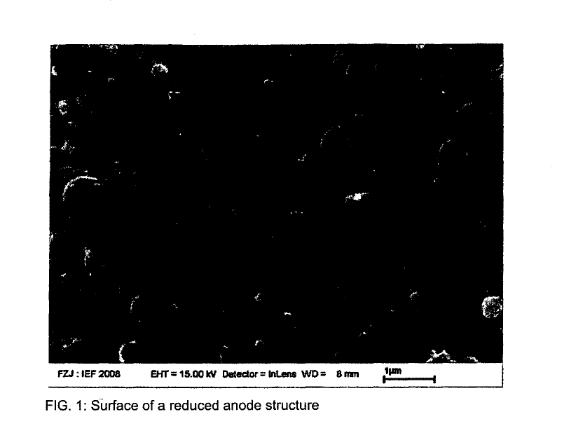

FIG. 1 shows the surface of a reduced anode structure (Ni/8YSZ), which is applied to a porous metallic substrate (ITM), which is not shown here. The geometry/dimensioning of the pores of the anode structure are relatively large.

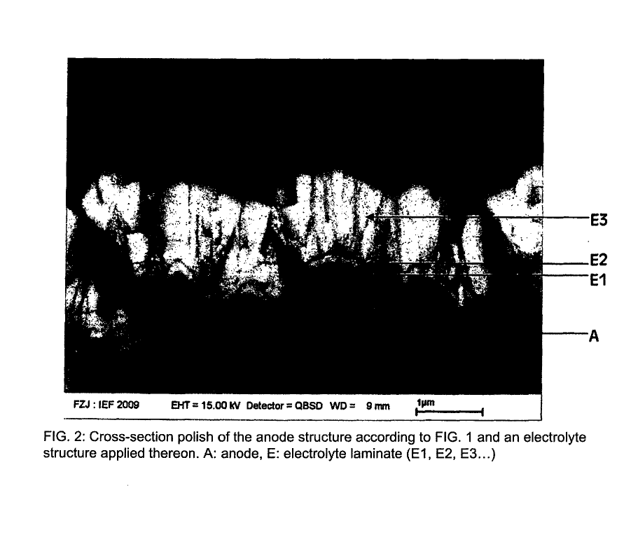

FIG. 2 shows a cross-section polish of the anode structure coated with the electrolyte according to FIG. 1. The multi-layer electrolyte was applied to the anode structure by means of PVD coating and is composed of a CGO layer (E1), an 8YSZ layer (E2), and a further CGO layer (E3). The columnar layer growth of the electrolyte having fanned, irregular growth is clearly apparent. The inhomogeneous growth of the electrolyte layers, notably on the nickel particles, prevents the required gas-tight layer composition of the electrolyte.

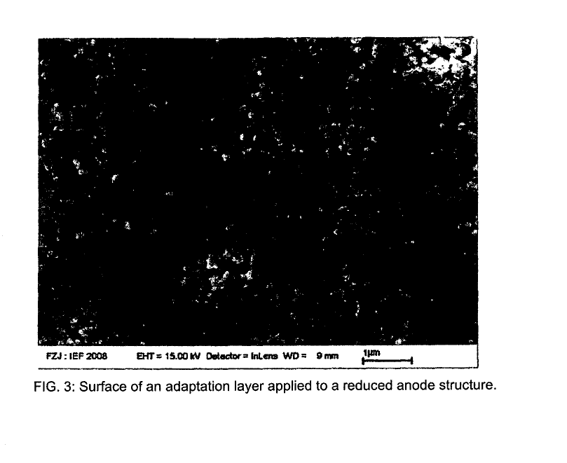

FIG. 3 shows the surface structure of the adaptation layer applied to the anode structure. It is clearly apparent that the size of the pores of the adaptation layer is considerably smaller than that of the anode structure according to FIG. 1.

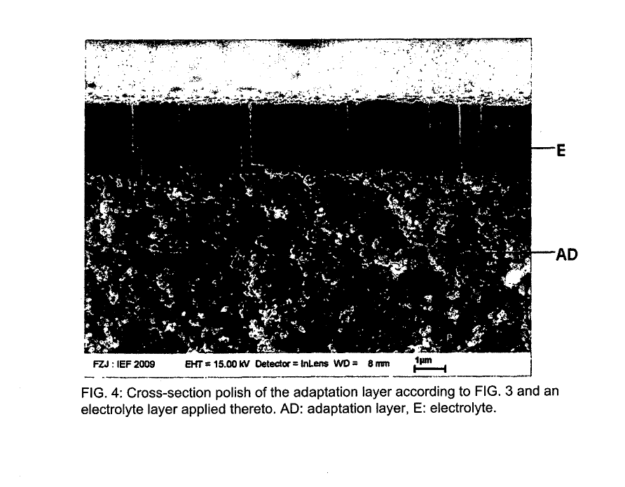

FIG. 4 shows a cross-section polish of the adaptation layer according to FIG. 3 and an electrolyte applied thereon. The electrolyte is the only layer made of CGO and was applied by way of a PVD method. The growth of the electrolyte layer is undisturbed and homogenous, whereby the required gas tightness of the electrolyte is achieved.

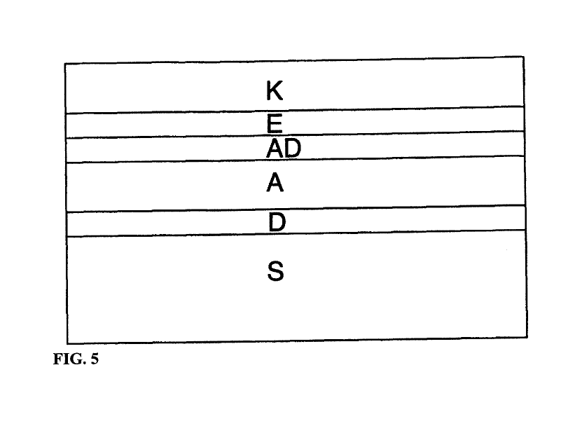

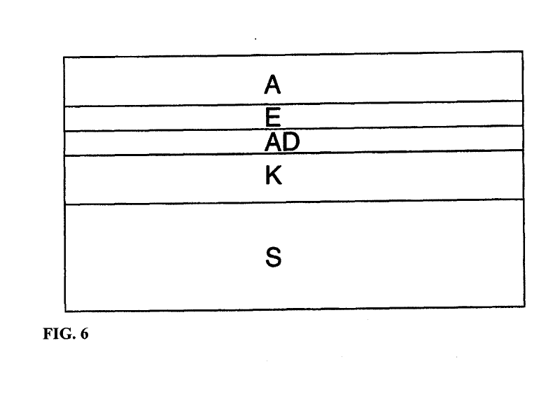

Examples of the composition of the assembly according to the invention, or the fuel cell, are shown schematically in FIGS. 5 and 6.

According to FIG. 5 (variant A), a porous anode structure A is applied to a metallic porous substrate S (ITM), which is provided with a diffusion barrier D. The following layers are applied consecutively to this anode structure: a porous adaptation layer AD, a gas-tight electrolyte layer E, and a porous cathode K. The following materials were used, for example, for this composition:

S: FeCr alloy or CFY alloy;
D: LSM or CGO diffusion barrier;
A: Ni/8YSZ (cermet mixture comprising nickel and zirconium dioxide stabilized with 8 mole percent yttrium oxide) or NiO/8YSZ (mixture comprising nickel oxide and zirconium dioxide stabilized with 8 mole percent yttrium oxide);
AD: YSZ (yttrium oxide-stabilized zirconia) or ScSZ (scandiumoxide-stabilized zirconia)

### E: CGO; and

### K: LSCF, LSM, or LSC.

According to FIG. 6 (variant B), a porous cathode K is applied to a metallic porous substrate S (ITM). The following layers are applied consecutively to this cathode structure K: a porous adaptation layer AD, a gas-tight electrolyte layer E, and a porous anode A. The following materials were used, for example, for this composition:

S: FeCr alloy or CFY alloy;

### K: LSM, LSCF, or LSC;

### AD: CGO;

### E: YSZ or ScSZ; and

### A: Ni/8YSZ or NiO/8YSZ.

The application of a gas-tight thin-film electrolyte entails certain demands, with respect to the layer structure located beneath, in terms of roughness and/or pore size, which can be satisfied by an adaptation layer. When powder-metallurgical porous substrates (for example having a particle size<125 μm) are coated with an anode structure, the latter can have a mean pore size of up to 1.5 μm (see FIG. 1). The roughness of the surface of this anode structure should have a root mean square roughness R_{q}^{μ} of less than 3 μm, and preferably less than 2 μm, a root mean square micro-roughness R_{q}^{μ} of less than 1 μm, and preferably less than 0.6 μm, average roughness depth R_{z}^{μ} of less than 10 μm, and preferably less than 6 μm, and mean micro-roughness depth n of less than 4 μm, and preferably less than 2 μm.

For determining roughness, the laser topography CT200 (Cybertechnologies GmbH, Ingolstadt) was used with an LT9010 confocal laser sensor (measuring spot size approximately 2 μm, vertical resolution 10 nm). Prior to application of the DIN regulations, the primary profiles measured in 1 μm increments were filtered using a Gaussian filter α=1n(2), filter length 5 μm, so as to minimize individual faulty signals due to multiple reflections.

For the particle and pore sizes of the sintered structure, which were determined by way of the intercepted segment method, at least three scanning electron microscopic images of cross-section polishes of the layers were evaluated in each case for each parameter. During this process, 500 to 1000 lines were drawn per image. With a pixel count for the scanning electronic images of 1024×768 pixels, a total section measuring 5 to 15 μm wide was selected for the adaptation layer.

For the adaptation layer, an 8YSZ powder having a mean dispersible primary particle size of 150 nm and a specific surface of 13 m²/g was used (TZ-8Y, Tosoh Corp., Japan). An immersion suspension consisting of 67.2% by weight solvent DBE (dibasic esters, LemroChemieprodukte Michael Mrozyk K G, Grevenbroich), 30.5% by weight 8YSZ powder (TZ-8Y), and 2.3% by weight ethyl cellulose as the binding agent (Fluka, 3-5.5 mPa s, Sigma-Aldrich Chemie GmbH, Munich) was mixed with grinding balls having a diameter of 5 and 10 mm, and homogenized on a roller bench for 48 hours. The carrier substrates, together with the anode structure applied thereto, were immersed vertically in the suspension, and, after a drying step, were sintered under an H₂ atmosphere at 1200° C. for 3 hours. According to the coating parameters (immersion speed, draining time), an adaptation layer thickness of 10 to 20 μm was obtained. The adaptation layer thus applied exhibited a root mean square roughness R_{q} of 1.2 μm, and an average roughness depth R_{z} of 5.8 μm. The root mean square micro-roughness R_{q}^{μ} showed a value of 0.21 μm, and the mean micro-roughness depth R_{z}^{μ} showed a value of 0.67 μm. In addition to this slight decrease in the roughness values, a clear decrease in the mean pore size on the surface of the adaptation layer was observed. While the surface of the anode structure had a mean pore size of approximately 610 nm (see FIG. 1), the mean pore size of the adaptation layer in this case was approximately 240 nm (see FIG. 3). A dense electrolyte layer comprising Gd₂O₃-doped CeO₂ (CGO) was applied to the adaptation layer by way of vapor deposition (electron beam evaporation at 870° C., EB-PVD), having a layer thickness of approximately 1.7 μm. The gas tightness of this electrolyte was determined by means of He leak testing at 3.4×10⁻³ (hPa dm³)/(s cm²) for a pressure differential of 1000 hPa. This value corresponds to common anode-supported fuel cells in the reduced state.

Literature Cited in this Application:
[1] T. S. Smith: “Morphological Characterization of Porous Coatings.” In: “Quantitative Characterization and Performance of Porous Implants for Hard Tissue Applications”, ASTM STP953, J. E. Lemmons, publisher, American Society for Testing and Materials, Philadelphia, 1987, pp. 92-102.
[2] M. I. Mendelson: “Average Particle Size in Polycrystalline Ceramics”, J. Am. Ceram. Soc. 52 [8] (1969), 443-446.

1. An assembly for a fuel cell, comprising an electrode, an electrolyte, and a metallic porous carrier substrate as the carrier for the electrode and the electrolyte an adaptation layer for adapting the electrolyte to the electrode is disposed between the electrode and the electrolyte, wherein the mean pore size of the adaptation layer is smaller than the mean pore size of this electrode.

2. The assembly according to claim 1, wherein the mean pore size of the adaptation layer is no more than half the mean pore size of the electrode.

3. The assembly according to claim 1, wherein the mean pore size of the adaptation layer does not exceed 500 nm, and preferably does not exceed 350 nm.

4. An assembly according to claim 1, wherein the root mean square surface roughness of the adaptation layer is less than 2.5 μm, preferably no more than 1.5 μm, and still more preferably no more than 1.0 μm.

5. An assembly according to claim 1, comprising a diffusion barrier between the carrier substrate and the electrode.

6. An assembly according to claim 1, wherein the electrode is designed as an anode.

7. An assembly according to claim 1, wherein the electrolyte is disposed directly on the layer surface of the adaptation layer which faces the electrolyte.

8. An assembly according to claim 1, wherein the adaptation layer has a thickness of 3 to 20 μm, and preferably of 3 to 7 μm.

9. An assembly according to claim 1, wherein the electrolyte has a thickness of 0.2 to 10 μm, and preferably of 1 to 3 μm.

10. An assembly according to claim 1, wherein the adaptation layer and/or the electrolyte comprises non-electron-conducting material.

11. The assembly according to claim 10, wherein the adaptation layer and/or the electrolyte comprises doped zirconium oxide, wherein the doping contains at least one oxide of the doping elements from the group consisting of Y, Sc, Al, Sr and Ca.

12. An assembly according to claim 1, wherein the adaptation layer and/or an electrolyte comprises ion- and electron-conducting material.

13. The assembly according to claim 12, wherein the adaptation layer and/or the electrolyte comprises doped cerium oxide, wherein the doping contains at least one oxide of the doping elements from the group of rare earth elements, such as Gd and Sm, and/or from the group consisting of Y, Sc, Al, Sr and Ca.

14. A method for producing an assembly for a fuel cell, comprising an electrode and an electrolyte, providing a metallic porous carrier substrate as the carrier for the electrode and the electrolyte, applying the electrode to the carrier substrate, applying a porous adaptation layer to the electrode for adapting the electrolyte to the electrode, wherein the mean pore size of the adaptation layer is smaller than the mean pore size of this electrode; and applying the electrolyte to the adaptation layer.

15. The method according to claim 14, comprising applying a diffusion barrier to the carrier substrate between the carrier substrate and the electrode.

16. The method according to claim 14, wherein the adaptation layer is applied to the electrode using a wet-chemical method.

17. A method according to claim 14, wherein the adaptation layer is applied as multiple layers.

18. A method according to claim 14, wherein the applied adaptation layer is treated by means of sintering.

19. The method according to claim 18, wherein the sintering temperature is 950 to 1300° C.

20. A method according to claim 14, wherein the electrolyte material is applied to the adaptation layer by means of vapor deposition or a sol-gel method.
